(19) United States
(12) Patent Application Publication
(10) Pub. No.: US 2026/0028864 A1
(43) Pub. Date: Jan. 29, 2026

(54) PROFILE FOR AT LEAST ONE COVER ELEMENT

(71) Applicant: Julius Blum GmbH, Hoechst (AT)

(72) Inventors: Florian FISCHER, Hoechst (AT); Gerhard KLEINSASSER, Dornbirn (AT); Hermann HAEMMERLE, Lustenau (AT); Matthias REISSIG, Lindau (DE); Alexander Simon FLOGAUS, Eriskirch (DE)

(21) Appl. No.: 19/349,467

(22) Filed: Oct. 3, 2025

Related U.S. Application Data
(63) Continuation of application No. PCT/AT2024/060128, filed on Apr. 10, 2024.

(30) Foreign Application Priority Data
Apr. 12, 2023 (AT) A 50266/2023

(51) Int. Cl. E05D 15/56; E06B 7/23

(52) U.S. Cl. CPC E05D 15/56; E06B 7/2309; E05Y 2201/626; E05Y 2201/684; E05Y 2900/148

(57) ABSTRACT

A profile for at least one cover element, preferably for a window, for covering at least one opening in a fixed structure, includes at least one interface for fastening the at least one cover element, and at least one profile body facing the fixed structure in the assembled state. The at least one profile body has at least one guide rail for guiding at least one carriage, and the at least one guide rail is substantially C-shaped in cross section.

The present application is a continuation of International Application PCT/AT2024/060128 filed on Apr. 10, 2024. Thus, all of the subject matter of International Application PCT/AT2024/060128 is incorporated herein by reference.

### BACKGROUND OF THE INVENTION

The present invention relates to a profile for at least one cover element, preferably for a window, for covering at least one opening in a fixed structure. The invention furthermore relates to an arrangement comprising at least one such profile and at least one, preferably substantially quadrilateral, cover element.

Profiles, for example, for windows, are well known from the prior art. However, these have an array of disadvantages: The profiles are connected to the fixed structure via fittings, wherein the fittings allow, for example, a pivot movement around a vertical axis. The fittings are visible to a user in every pivot position of the profile, which diminishes the aesthetic impression created by the profile and a cover element connected thereto. In addition, installation space is required for attaching the fitting to the profile on the one hand and to the fixed structure on the other hand, which is lost for the area of the cover element.

Another problem, in particular with profiles made of plastic, is that they have reduced torsional rigidity.

### SUMMARY OF THE INVENTION

The object of the present invention is to specify a profile improved over the prior art, in which the disadvantages known from the prior art are at least partially eliminated. Furthermore, an arrangement having at least one profile improved in this way and at least one cover element is to be specified.

Accordingly, it is provided that the profile for at least one cover element, preferably for a window, for covering at least one opening in a fixed structure, comprises at least one interface for fastening the at least one cover element and at least one profile body facing toward the fixed structure in the installed state, wherein the at least one profile body has at least one guide rail, which is substantially C-shaped in cross section, for guiding at least one carriage.

Because the profile comprises at least one guide rail, a connection interface is provided, via which the profile can be connected to the fixed structure. Furthermore, the integration of the guide rail into the at least one profile body results in a compact design, which saves installation space, which can subsequently be used for the area of the cover element. At the same time, the guide rail is at least partially covered on the outside by the profile body, which allows for aesthetically pleasing architectural appearances. Another significant advantage results in particular in profile bodies made of plastic in that the guide rail can be used to stiffen the profile body, due to which the guide rail fulfills another function in addition to its actual function of guiding a carriage. In addition, in comparison to tilt fittings, the guide rail allows harmonious movement courses of the at least one cover element for the user.

Advantageous exemplary embodiments are that the at least one guide rail is formed integrally in the at least one profile body and/or is integrated in the form of at least one insert part in the at least one profile body. In an integral design, a channel can be provided in the profile body, for example, which functions as a guide rail. The use of an insert part is particularly advantageous when the profile body and the guide rail are made of different materials, e.g. aluminum/steel or plastic/steel.

Preferably, the at least one profile body is made of aluminum, preferably of an aluminum extruded profile, and/or of at least one plastic, and/or wherein the profile body is designed as a hollow profile body. Aluminum conveys a high-quality impression, especially in window construction. Plastic has advantageous thermal insulation properties. The use of a hollow profile body is also advantageous from the point of view of thermal insulation, since insulation made of air cushions and/or insulating materials can be integrated.

Alternatively or additionally, the profile can have at least one outer seal for contact, preferably at the front side, with the fixed structure.

It has proven to be advantageous that the at least one interface has at least one, preferably two, seals, preferably made of silicone, and/or at least one support profile, preferably made of aluminum, for supporting the at least one cover element, and/or at least one, preferably materially-bonded, holding device, preferably in the form of a double-sided adhesive tape.

Soft materials, thus not only silicone, come into consideration as the material for the at least one seal. For example, the at least one seal can also be made of EPDM (ethylene propylene diene (monomer) rubber) or rubber.

Alternatively or additionally, the profile can have at least one support structure arranged between the at least one interface and the at least one profile body. Preferably, the at least one support structure comprises at least one insulation and/or is formed from at least one plastic. The support structure can serve as a cold bridge interrupter.

As stated at the outset, protection is also sought for an arrangement having at least one profile according to the invention and at least one, preferably substantially quadrangular, cover element. The at least one cover element is fastened to the at least one profile via the at least one interface, and preferably the at least one cover element is designed as a window, in particular comprising triple insulating glass.

According to an advantageous exemplary embodiment of the arrangement, the at least one cover element has at least one, preferably substantially cuboid, recess on at least one, preferably two, outer edges, into which the at least one profile is inserted, preferably wherein the at least one profile is covered by the at least one cover element on at least two side surfaces. This exemplary embodiment has a particularly attractive shape, since the at least one profile can be covered substantially completely on the outside by the at least one cover element, at least in a closed state of the at least one cover element.

Alternatively or additionally, the at least one cover element has two outer edges which are essentially horizontal in the installed position and along each of which at least one profile is arranged.

It has proven to be particularly advantageous that the arrangement comprises at least one, preferably more than one, guide device. The at least one guide device has at least one carriage, preferably having at least one roller body, for displaceable mounting in the at least one guide rail of the profile, preferably in a longitudinal direction of the at least one guide rail, and at least one support body for fastening the at least one guide device to the fixed structure. By such a guide device, the profile and the cover element arranged thereon can be fastened to the fixed structure in a technically simple and compact form. Preferably, more than one such guide device is used, for example, two or four guide devices. In the case of a substantially quadrangular cover element, the use of one guide device per corner is recommended, and preferably two of the four guide devices are arranged mirror-symmetrically to the other two guide devices, so that in the case of two guide devices the support bodies are each arranged on the fixed structure and in the case of the other two guide devices the support bodies are each arranged on the at least one cover element.

It has proven to be advantageous that the at least one carriage and the at least one support body are connected to one another via at least one articulated lever mechanism. Preferably, the at least one articulated lever mechanism has at least two support levers articulated to one another via a first joint axis, and at least two drive levers articulated to one another via a second joint axis, particularly preferably wherein the first joint axis and the second joint axis extend substantially orthogonally to one another.

Alternatively or additionally, the arrangement has at least one frame profile body for fastening to the fixed structure, and preferably the at least one frame profile body has at least one frame guide rail for guiding at least one carriage. Particularly preferably, the at least one frame guide rail, which is substantially C-shaped in cross section, is arranged substantially parallel to the at least one guide rail of the at least one profile. The at least one frame guide rail can be integrally formed in the at least one frame profile body and/or integrated in the form of at least one insert part into the at least one frame profile body.

It is advisable that the at least one frame profile body has at least one central seal for contact with the at least one profile body of the at least one profile, and/or is made of aluminum and/or at least one plastic, and/or has at least one frame support body, preferably made of at least one plastic, and/or comprises at least one outer partial profile facing the at least one cover element and at least one inner partial profile. Preferably, the two partial profiles are connected or connectable to one another via at least one connector, preferably made of at least one plastic, and/or has at least one insulation. By providing at least one outer partial profile facing toward the at least one cover element and at least one inner partial profile, the frame profile body can be modularly adapted to different installation depths.

Advantageously, the arrangement can have at least one reveal which covers the at least one frame profile body, and preferably the at least one reveal is formed from aluminum and/or at least one plastic, and/or has at least one inner seal for contact with the at least one profile body of the at least one profile.

It has proven to be particularly advantageous that the arrangement has at least one fixed structure having at least one opening. The at least one cover element is mounted so as to be movable between a closed position, in which the cover element essentially covers the at least one opening, and an open position, in which the at least one cover element is spaced apart essentially orthogonally from the at least one opening, and preferably a displacement position, in which the at least one cover element is arranged laterally offset in relation to the at least one opening. Preferably, the at least one cover element in the closed position is recessed essentially flush with the surface in the fixed structure.

### BRIEF DESCRIPTION OF THE DRAWINGS

Further details and advantages of the invention will be explained in more detail below with reference to the drawings, in which:

FIG. 1 shows a first exemplary embodiment of an arrangement having a fixed structure and a cover element in a perspective view,

FIGS. 2 to 4 show the first exemplary embodiment in a side view (FIG. 2) and a cross-sectional view along the cross-sectional plane 49 (FIG. 3), wherein FIG. 4 shows an enlarged detail 50 of the cross-sectional view,

FIG. 5 shows a second exemplary embodiment in a cross-sectional view, wherein the detail 50 is shown enlarged,

FIGS. 6 to 8 show a further exemplary embodiment of an arrangement having a fixed structure and a cover element, wherein the cover element is arranged in a closed position (FIG. 6), an open position (FIG. 7) and in a displacement position (FIG. 8), each in a perspective view,

FIGS. 9 to 11 show an exemplary embodiment of an arrangement made up of two guide rails and two frame guide rails, which are connected to one another via four guide devices, wherein the arrangement is shown in FIG. 9 in the closed position, in FIG. 10 in the open position, and in FIG. 11 in the displacement position, each in a perspective view, wherein the section 51 is shown enlarged, and

FIGS. 12 to 14 show an exemplary embodiment of a guide device in the closed position (FIG. 12), the open position (FIG. 14), and an intermediate position (FIG. 13), each in a perspective view.

### DETAILED DESCRIPTION OF THE INVENTION

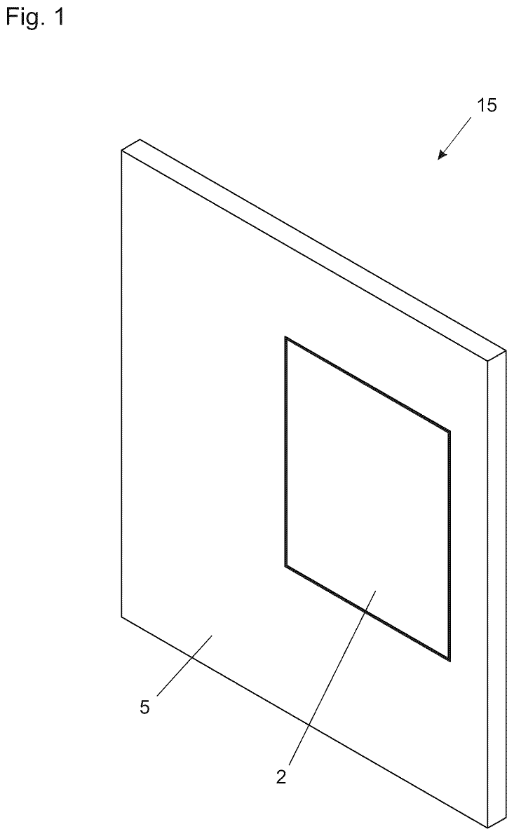

FIGS. 1 to 4 show a first exemplary embodiment of an arrangement 15 having at least one profile 1 and at least one, preferably substantially quadrangular, cover element 2, wherein the at least one cover element 2 is fastened to the at least one profile 1 via the at least one interface 3, preferably wherein the at least one cover element 2 is designed as a window, in particular comprising triple insulating glass. In the case of triple insulating glass, three glazings 46 are provided.

The cover element 2 is designed to cover an opening 40 in the fixed structure 5.

The profile 1 comprises at least one interface 3 for fastening the at least one cover element 2 and at least one profile body 6 facing toward the fixed structure 5 in the installed state, wherein the at least one profile body 6 has at least one guide rail 7, which is substantially C-shaped in cross section, for guiding at least one carriage 8.

The at least one guide rail 7 is integrated in the form of at least one insert part into the at least one profile body 6.

The at least one profile body 6 is made of aluminum, preferably of an extruded aluminum profile, and is designed as a hollow profile body.

The profile 1 has at least one outer seal 9 for contact, preferably at the front side, with the fixed structure 5.

The at least one interface 3 for fastening the at least one cover element 2 has seals 10, preferably made of silicone, wherein a first seal 10 is arranged between an end face of the cover element 2, preferably an end face of a front glass element of the cover element 2, and at least one support profile 11 and a further seal 10 is arranged between a side face of the cover element 2, preferably a side face of a front glass element of the cover element 2, and the at least one support profile 11. The two seals 10 are spaced apart from one another.

The at least one support profile 11, preferably made of aluminum, is designed to support the at least one cover element 2.

The interface 3 has at least one, preferably materially-bonded, holding device 12, preferably in the form of a double-sided adhesive tape, preferably wherein the holding device 12 is arranged between the seals 10.

The profile 1 has at least one support structure 13, which is arranged between the at least one interface 3 and the at least one profile body 6, wherein the at least one support structure 13 comprises at least one insulation 14 and is formed from at least one plastic.

The at least one cover element 2 has at least one, preferably substantially cuboid, recess 18 on at least one, preferably two, outer edges 16, 17, into which the at least one profile 1 is inserted, preferably wherein the at least one profile 1 is covered by the at least one cover element 2 on at least two side surfaces 19, 20. In this way, the profile 1 is integrated into an imaginary, essentially cuboid volume of the cover element 2, resulting in a compact design and an aesthetic appearance.

In the concretely illustrated exemplary embodiment, the at least one cover element 2 has two outer edges 16, 17 at the top and bottom, which are essentially horizontal in the installed position, and along each of which at least one profile 1 is arranged.

The arrangement 15 has at least one frame profile body 29 for fastening to the fixed structure 5, in particular to a window frame of a fixed structure 5, wherein the at least one frame profile body 29 has at least one frame guide rail 30 for guiding at least one carriage 8, wherein the at least one frame guide rail 30, which is substantially C-shaped in cross section, is arranged substantially parallel to the at least one guide rail 7 of the at least one profile 1.

The at least one frame profile body 29 has at least one middle seal 31 for contact with the at least one profile body 6 of the at least one profile 1, is made of aluminum and at least one plastic, and has at least one frame support body 32, preferably made of at least one plastic.

The at least one frame profile body 29 comprises at least one outer partial profile 33 facing toward the at least one cover element 2 and at least one inner partial profile 34, preferably wherein the two partial profiles 33, 34 are connected or connectable to one another via at least one connector 35, preferably made of at least one plastic.

The at least one frame profile body 29 has at least one insulation 36.

The arrangement 15 has at least one reveal 37 which covers the at least one frame profile body 29, wherein the at least one reveal 37 is formed from aluminum and has at least one inner seal 39 for contact with the at least one profile body 6 of the at least one profile 1. Insulation 45 can be arranged in the reveal 37. Alternatively or additionally, the reveal 37 can comprise at least one end bracket 47, preferably made of aluminum, preferably wherein the end bracket 47 faces toward an inner side of the fixed structure 5.

Overall, for example, three seal levels can be provided, which are formed by an outer seal 9, a middle seal 31, and an inner seal 39. In this exemplary embodiment and in the exemplary embodiment described below, the seals all act in the same direction transverse to the at least one cover element.

A facade cladding 41, preferably made of aluminum, and/or a facade insulation 42 can be arranged on an outer side of the fixed structure 5. Alternatively or additionally, an inner cladding 43, preferably made of aluminum, and/or insulation 44 can be arranged on an inner side.

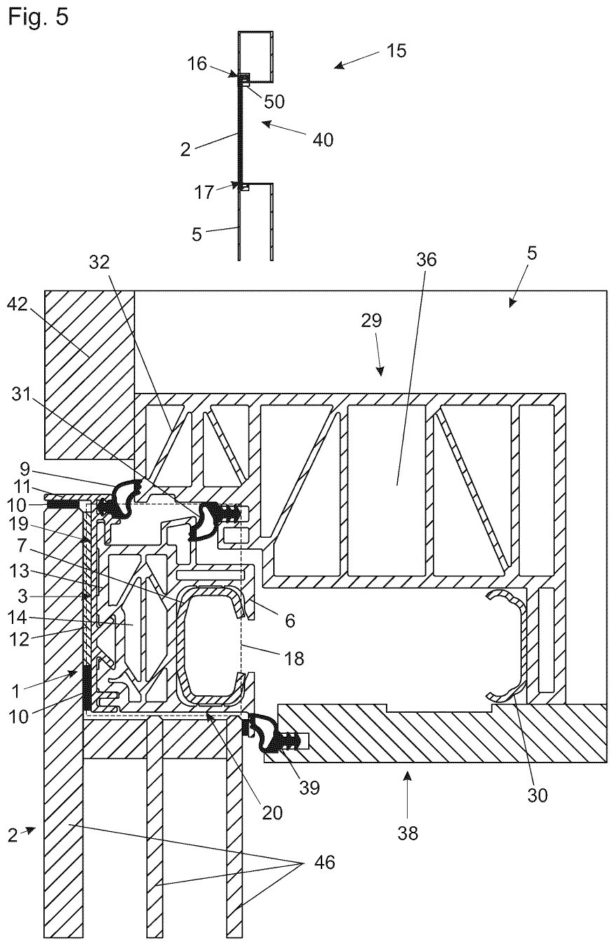

FIG. 5 shows a second exemplary embodiment of an arrangement 15. The profile 1 and the assembly on the fixed structure 5, comprising the frame profile body 29, are designed similarly to the first exemplary embodiment, so that only the essential differences are mentioned below.

The at least one profile body 6 is formed from at least one plastic. The support structure 13 is integrally formed with the profile body 6. Hollow chambers containing air are formed in the support structure 13, which act as insulation 14.

The frame profile body 29 is made of at least one plastic and is integrally connected to the frame support body 32.

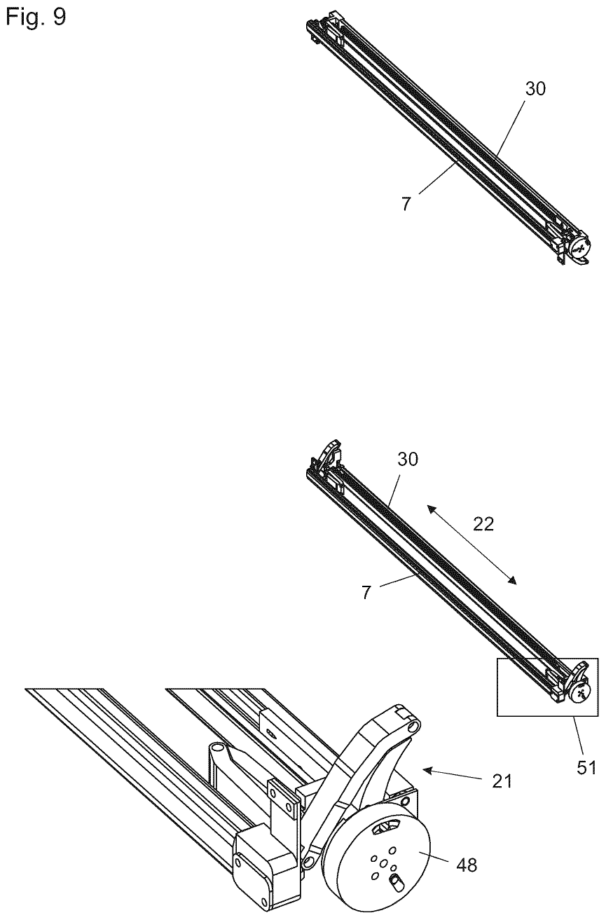

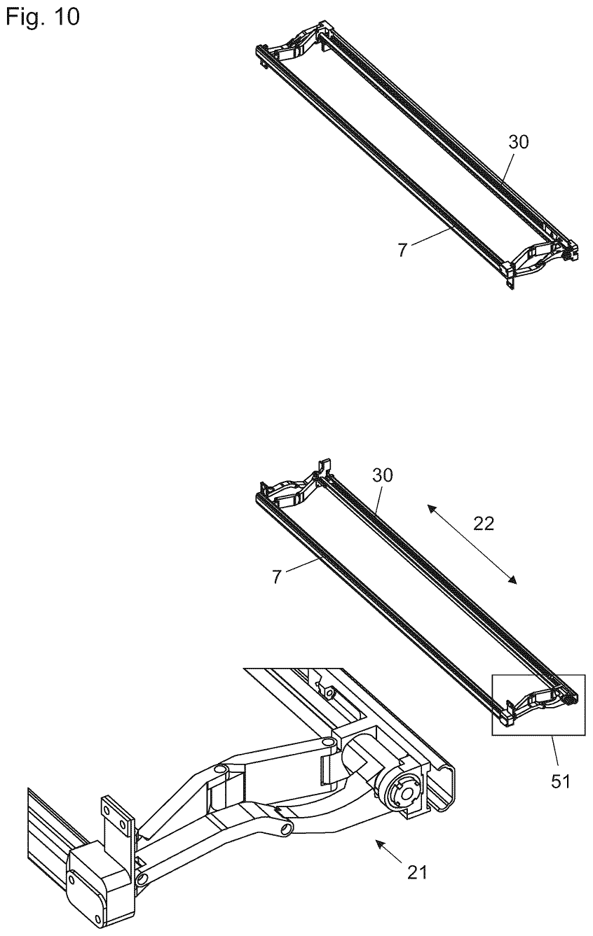

The guide rail 7 and the frame guide rail 30 are made of steel, for example, and are used, in addition to guiding at least one carriage 8 (see FIG. 9 et seq.), to stiffen the profile body 6 or the frame profile body 29.

The reveal 38 can be formed, for example, from a board, preferably made of wood or made of a wood-like material.

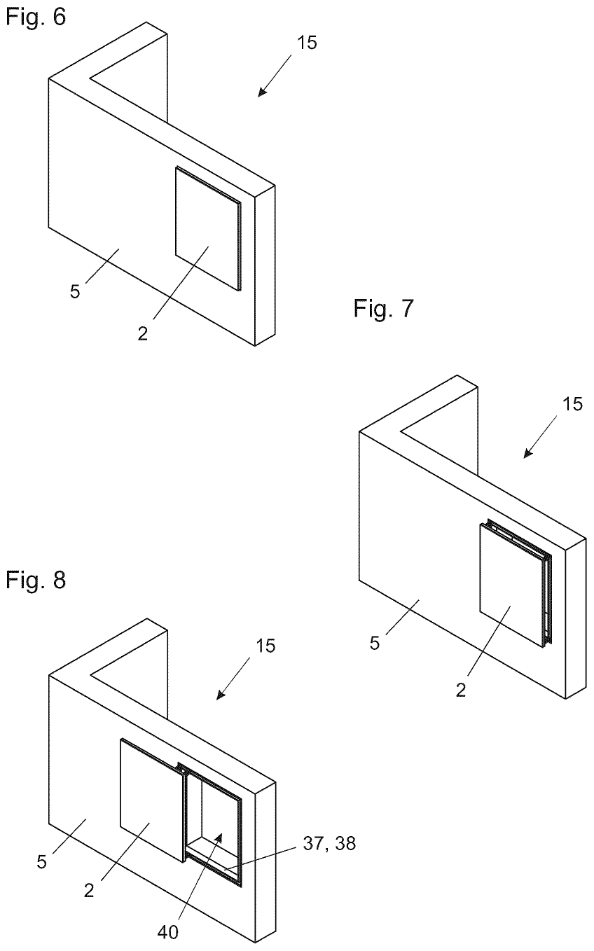

FIGS. 6 to 8 show a further exemplary embodiment of an arrangement 15 having a fixed structure 5 and a cover element 2. In this case, for example, the profiles 1 and/or frame profile bodies 29 shown in FIG. 4 or in FIG. 5 can be installed.

The arrangement 15 has at least one fixed structure 5 having at least one opening 40, wherein the at least one cover element 2 is mounted so as to be movable between a closed position (FIG. 6), in which the cover element 2 essentially covers the at least one opening 40, and an open position (FIG. 7), in which the at least one cover element 2 is spaced apart essentially orthogonally from the at least one opening 40, and preferably a displacement position (FIG. 8), in which the at least one cover element 2 is arranged laterally offset in relation to the at least one opening 40, preferably wherein the at least one cover element 2 in the closed position is recessed essentially flush with the surface in the fixed structure 5.

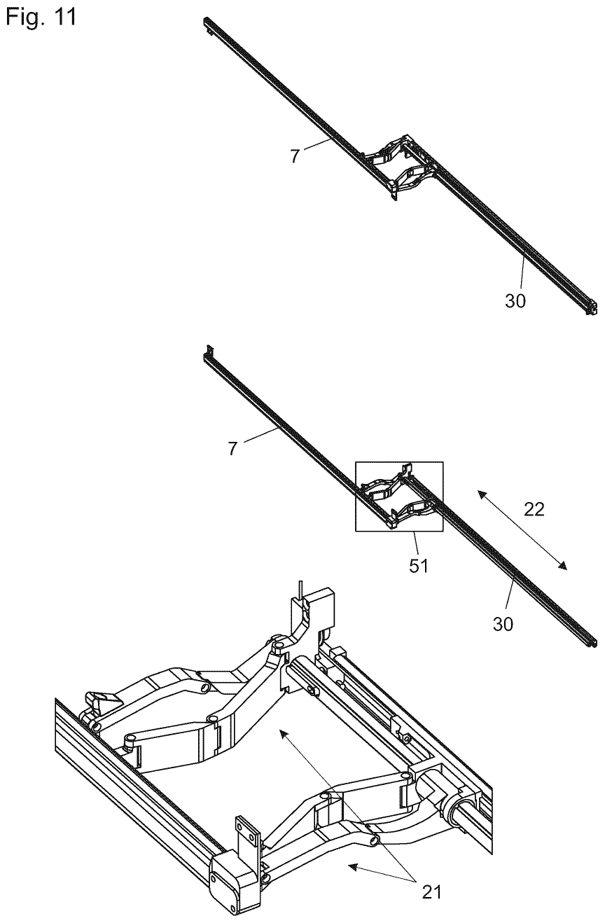

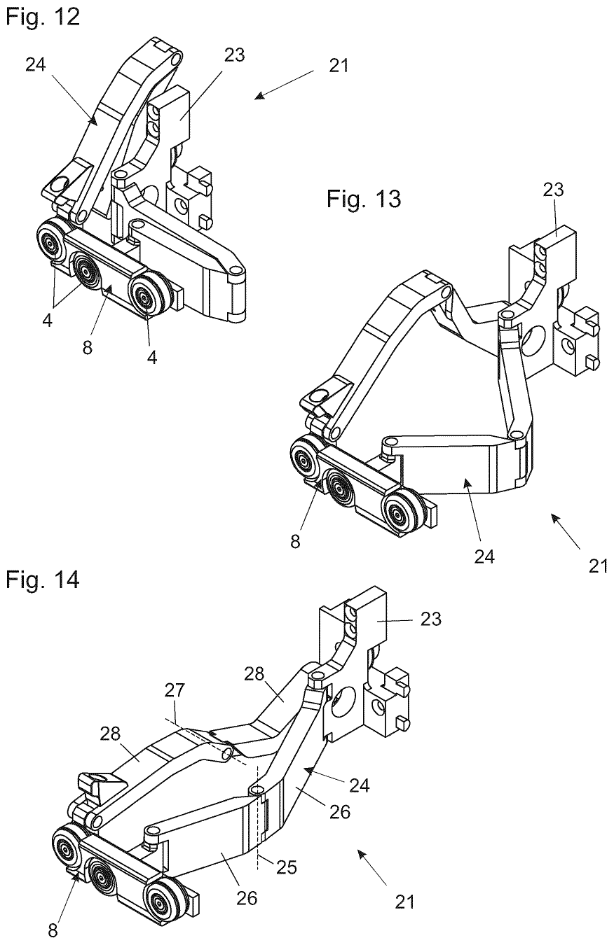

FIGS. 9 to 11 show an exemplary embodiment of an arrangement comprising two guide rails 7 and two frame guide rails 30, which are connected to one another via four guide devices 21, wherein the arrangement is shown in FIG. 9 in the closed position, in FIG. 10 in the open position, and in FIG. 11 in the displacement position. FIGS. 12 to 14 show an exemplary embodiment of the guide device 21 in the closed position (FIG. 12), the open position (FIG. 14), and an intermediate position (FIG. 13).

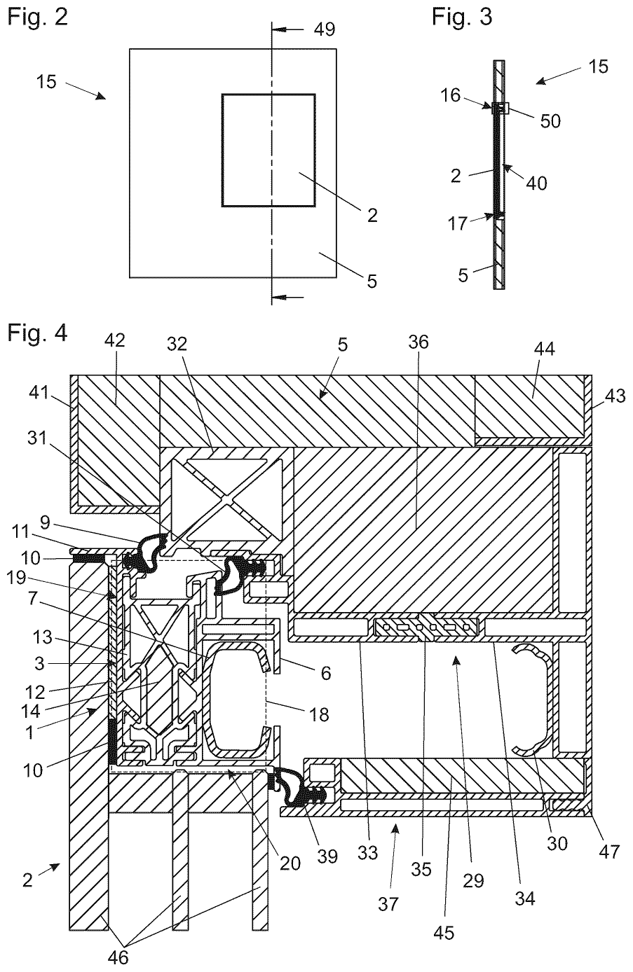

The arrangement shown in FIGS. 9 to 11 can be used in the exemplary embodiment shown in FIGS. 2 to 4 or FIG. 5 in order to movably mount the profile 1 on the fixed structure 5. In this case, a first pair made up of a guide rail 7 and a frame guide rail 30 can be arranged on the upper outer edge 16 of the cover element 2 and a second pair made up of a guide rail 7 and a frame guide rail 30 can be arranged on the lower outer edge 17 of the cover element 2.

The four guide devices 21 can be designed essentially identically, wherein in each case one guide device 21 is connected in a movement-coupled manner to the guide rail 7 and one guide device 21 is connected in a movement-coupled manner to the frame guide rail 30, due to which a mirror-symmetrical arrangement of the guide devices 21 results. In the concrete case shown, the respective right guide devices 21 move along with the cover element 2 during a lateral displacement movement of the cover element 2, wherein the left guide devices 21 are arranged in a stationary manner on the fixed structure 5.

The guide devices 21 arranged on the fixed structure 5 each comprise at least one carriage 8, preferably having at least one roller body 4, for displaceable mounting in the at least one guide rail 7 of the profile 1, preferably in a longitudinal direction 22 of the at least one guide rail 7, and at least one support body 23 for fastening the guide devices 21 to the fixed structure 5.

The guide devices 21 which are coupled in movement to the cover element 2 each comprise at least one carriage 8, preferably having at least one roller body 4, for displaceable mounting in the at least one frame guide rail 30 of the frame profile body 30, preferably in a longitudinal direction 22 of the at least one frame guide rail 30, and at least one support body 23 for fastening the guide devices 21 to the cover element 2 or to the profile 1.

Movements of the guide devices 21, in particular during a movement of the cover element 2 from the closed position to the open position, can be synchronized with one another via at least one synchronization device. For this purpose, for example, a drive shaft 48 can be provided, which can be coupled, for example, to at least one, preferably electrical, drive device.

As can be seen in particular from FIGS. 12 to 14, the at least one carriage 8 and the at least one support body 23 can connected to one another via at least one articulated lever mechanism 24, preferably wherein the at least one articulated lever mechanism 24 has at least two support levers 26 articulated to one another via a first joint axis 25, and at least two drive levers 28 articulated to one another via a second joint axis 27, particularly preferably wherein the first joint axis 25 and the second joint axis 27 extend substantially orthogonally to one another.

1. A profile for a cover element, preferably for a window, for covering an opening in a fixed structure, the profile comprising:
at least one interface for fastening the cover element, and
at least one profile body facing toward the fixed structure in the installed state,
wherein the at least one profile body has at least one guide rail for guiding at least one carriage, the at least one guide rail being substantially C-shaped in cross section.

2. The profile according to claim 1, wherein the at least one guide rail is formed integrally in the at least one profile body and/or is integrated in the form of at least one insert part in the at least one profile body.

3. The profile according to claim 1, wherein the at least one profile body is made of aluminum, preferably of an aluminum extruded profile, and/or of at least one plastic, and/or wherein the profile body is designed as a hollow profile body.

4. The profile according to claim 1, wherein the profile has at least one outer seal for contact, preferably at the front side, with the fixed structure.

5. The profile according to claim 1, wherein the at least one interface:
has at least one, preferably two, seal(s), preferably made of silicone, and/or
at least one support profile, preferably made of aluminum, for supporting the at least one cover element, and/or
at least one, preferably materially-bonded, holding device, preferably in the form of a double-sided adhesive tape.

6. The profile according to claim 1, wherein the profile has at least one support structure, which is arranged between the at least one interface and the at least one profile body, wherein the at least one support structure comprises at least one insulation, and/or is formed from at least one plastic.

7. An arrangement comprising:
the profile according to claim 1, and
at least one, preferably substantially quadrangular, cover element,
wherein the at least one cover element is fastened to the at least one profile via the at least one interface, preferably wherein the at least one cover element is designed as a window, in particular comprising triple insulating glass.

8. The arrangement according to claim 7, wherein the at least one cover element has at least one, preferably substantially cuboid, recess on at least one, preferably two, outer edges, into which the at least one profile is inserted, preferably wherein the at least one profile is covered by the at least one cover element on at least two side surfaces.

9. The arrangement according to claim 7, wherein the at least one cover element has two outer edges which are substantially horizontal in the assembled position and along which the profile is arranged.

10. The arrangement according to claim 7, wherein the arrangement comprises at least one, preferably more than one, guide device, wherein the at least one guide device has at least one carriage, preferably with at least one roller body, for displaceable mounting in the at least one guide rail of the profile, preferably in a longitudinal direction of the at least one guide rail, and at least one support body for fastening the at least one guide device to the fixed structure.

11. The arrangement according to claim 10, wherein the at least one carriage and the at least one support body are connected to one another via at least one articulated lever mechanism, preferably wherein the at least one articulated lever mechanism has at least two support levers articulated to one another via a first joint axis, and at least two drive levers articulated to one another via a second joint axis, particularly preferably wherein the first joint axis and the second joint axis extend substantially orthogonally to one another.

12. The arrangement according to claim 7, wherein the arrangement has at least one frame profile body for fastening to the fixed structure, preferably wherein the at least one frame profile body has at least one frame guide rail for guiding at least one carriage, wherein the at least one frame guide rail, which is substantially C-shaped in cross section, is arranged substantially parallel to the at least one guide rail of the at least one profile.

13. The arrangement according to claim 12, wherein the at least one frame profile body:
has at least one central seal for contact with at least one profile body of the at least one profile, and/or
is made of aluminum and/or at least one plastic, and/or
at least one frame support body, preferably made of at least one plastic, and/or
comprises at least one outer partial profile facing toward the at least one cover element and at least one inner partial profile, preferably wherein the two partial profiles are connected or connectable to one another via at least one connector, preferably made of at least one plastic, and/or
has at least one insulation.

14. The arrangement according to claim 7, wherein the arrangement has at least one reveal which covers the at least one frame profile body, preferably wherein the at least one reveal is formed from aluminum and/or at least one plastic, and/or has at least one inner seal for contact with the at least one profile body of the at least one profile.

15. The arrangement according to claim 7, wherein the arrangement has at least one fixed structure having at least one opening, wherein the at least one cover element is mounted so as to be movable between a closed position, in which the cover element essentially covers the at least one opening, and an open position, in which the at least one cover element is spaced apart essentially orthogonally from the at least one opening, and preferably a displacement position, in which the at least one cover element is arranged laterally offset in relation to the at least one opening, preferably wherein the at least one cover element in the closed position is recessed essentially flush with the surface in the fixed structure.
